(19) United States
(12) Patent Application Publication
(10) Pub. No.: US 2002/0109907 A1
(43) Pub. Date: Aug. 15, 2002

(54) Dynamic gain slope compensator

(76) Inventors: Paul Chen, Monterey Park, CA (US); Glenn E. Kohnke, Painted Post, NY (US); Yongqian Liu, San Diego, CA (US); Dan W. Nightingale, Lindley, NY (US)

Correspondence Address: Svetlana Short, Corning Incorporated, SP-TI-3-1, Corning, NY, 14831, US

(21) Appl. No.: 09/727,183

(22) Filed: Nov. 30, 2000

(51) Int. Cl. H01S 3/00

(52) U.S. Cl. 359/337

(57) ABSTRACT

A dynamic slope compensation filter (DSCF) provides dynamic gain slope modification for an optical amplifier. The optical amplifier provides amplification for a plurality of wavelengths within an amplification band. The filter includes an optical waveguide core, an optical waveguide cladding and an optical waveguide overcladding. The optical waveguide core guides a plurality of wavelengths. The core has a core refractive index and includes at least one coupler that functions to couple at least a portion of the plurality of wavelengths from the core to the cladding. The optical waveguide cladding surrounds the core and has a cladding refractive index that is less than the core refractive index. The optical waveguide overcladding surrounds at least a portion of the cladding and has a variable overcladding refractive index that is adjustable within a range that is less than and greater than the cladding refractive index. At least one of a trailing edge and a leading edge of a filter loss peak of the filter covers substantially all of the amplification band.

### BACKGROUND OF THE INVENTION

1. Field of the Invention

The present invention is generally directed to gain slope compensation of an optical amplifier and more particularly to dynamic gain slope compensation of an optical amplifier.

2. Technical Background

Many wavelength division multiplexed optical communication networks utilize erbium-doped fiber amplifiers (EDFAs) to provide amplification for a band of multiplexed signals. However, because the intrinsic EDFA gain spectrum is not flat, passive gain flattening filters (GFFs) have been utilized to modify the gain spectrum to achieve a desired gain flatness over the signal band for reliable system performance of the optical communication network. A passive GFF typically addresses system signal deterioration attributable to gain ripple and is normally adequate when input power is constant, which typically occurs when span loss, temperature, and number of input channels are constant. When span loss and temperature are variable, however, a passive GFF typically does not provide adequate compensation for gain ripple. In addition, other variables such as component loss variation, fiber length, fiber type, pump laser wavelength, splice loss variation and other factors that affect the inversion state of a given optical amplifier can reduce the effectiveness of a passive GFF. Further, intrinsic gain ripple is affected by filter absorption, inversion and inhomogeneous spectral broadening, among other factors.

Amplifier gain tilt, which also affects the amplifier gain spectrum, is typically categorized as being either dynamic or thermal. Dynamic gain tilt is typically caused by inversion changes of a given optical amplifier due to input power, fiber length or passive loss. Thermal gain tilt is generally the result of absorption spectra changes with temperature. Current techniques, which mitigate dynamic gain tilt, tend to reduce power efficiency of a given optical amplifier. Gain tilt, like gain ripple, is normally undesirable and should be addressed such that it cannot accumulate in an optical network and degrade the performance of the network.

Traditionally, gain tilt has been controlled by minimizing the variation of the parameters which cause the gain tilt. For example, pump lasers used with EDFAs have been both wavelength and intensity stabilized to eliminate the gain tilt caused by the pump laser. Further, thermal gain tilt has been minimized by holding a given EDFA at a constant temperature. In many cases, these approaches have been effective to provide acceptable results. However, as EDFAs have been extended from the C-band (conventional band; approximately 1530-1565 nm) to the L-band (long wavelength band; approximately 1570-1605 nm), in response to the increased demand for bandwidth; this approach has generally proven to be less effective. That is, gain tilt in the L-band is more sensitive to temperature change and pump wavelength change. As such, EDFAs that operate in the L-band generally require better pump and temperature control. Further, maintaining the erbium fiber at a constant temperature becomes increasingly difficult as EDFA modules are reduced in size.

Thus, it is desirable to develop alternative techniques that can eliminate or compensate for gain tilt in optical amplifiers (e.g., EDFAs).

### SUMMARY OF THE INVENTION

The present invention is directed to a dynamic slope compensation filter (DSCF) that provides dynamic gain slope modification for an optical amplifier, which provides amplification for a plurality of wavelengths within an amplification band. The filter includes an optical waveguide core, an optical waveguide cladding and an optical waveguide overcladding. The optical waveguide core guides a plurality of wavelengths, has a core refractive index and includes at least one coupler. The coupler functions to couple a plurality of wavelengths from the core to the cladding, which surrounds the core. The cladding has a cladding refractive index that is less than the core refractive index. The optical waveguide overcladding surrounds at least a portion of the cladding and has a variable overcladding refractive index that is adjustable within a range that is less than and greater than the cladding refractive index. At least one of a trailing edge and a leading edge of a filter loss peak of the filter covers substantially all of the amplification band.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

FIG. 1 is an axial sectional view of a dynamic slope compensation filter (DSCF) that includes an athermalized fiber coupler surrounded by an overcladding and a thermal conditioner;

FIG. 2 is a transverse cross-sectional view of the DSCF of FIG. 1 taken along section II-II of FIG. 1;

FIG. 3 is graph of the insertion loss spectra of a tunable long-period grating (LPG) as a function of grating temperature;

FIG. 4 is a graph of the insertion loss spectra of a gain slope compensation filter in the L-band as a function of the input electric power applied to a heater of the DSCF of FIG. 1; and

FIG. 5 is a diagram of an optical amplification system incorporating the DSCF of FIG. 1.

### DETAILED DESCRIPTION OF THE PREFERRED EMBODIMENT

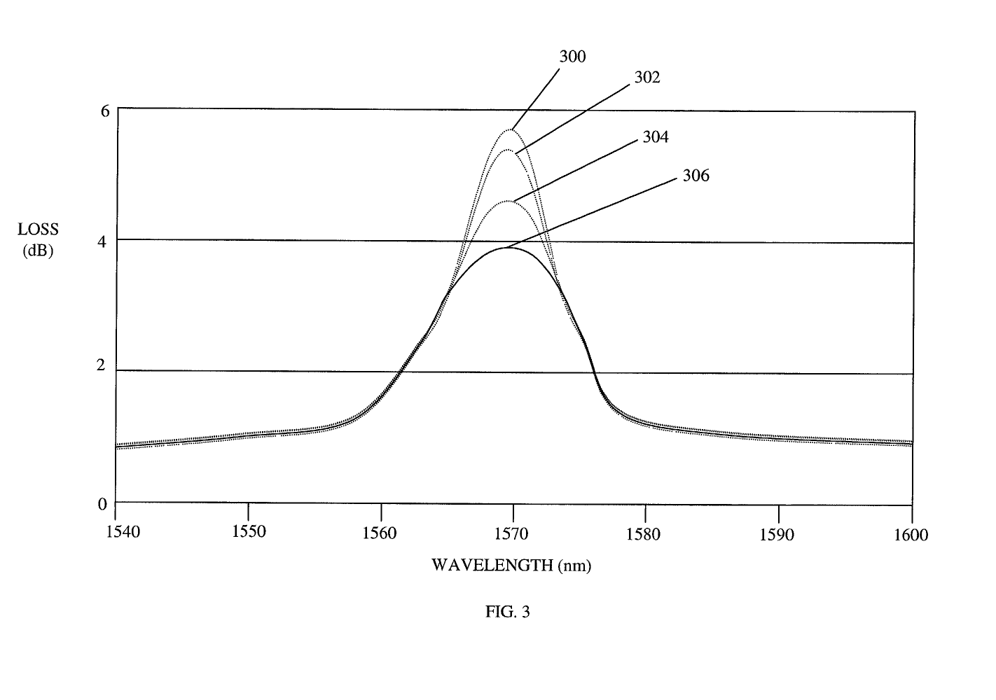

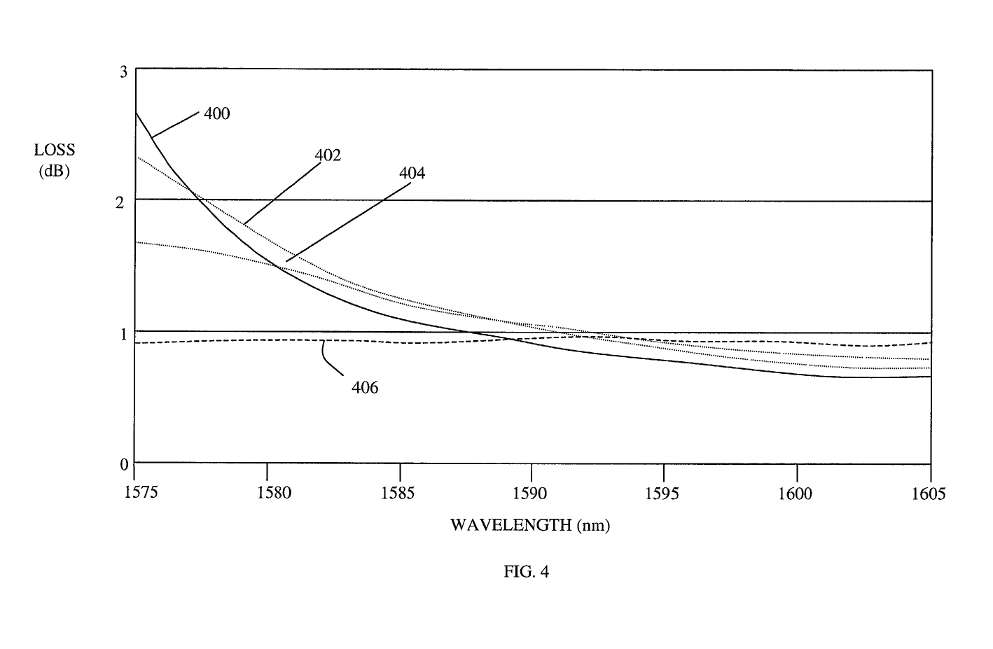

The present invention is directed to a long-period grating (LPG) based dynamic slope compensation filter (DSCF) that is capable of correcting gain tilt of an optical amplifier (e.g., an erbium-doped fiber amplifier (EDFA)). A DSCF, according to the present invention, is a fiber-based component that is simple, compact and provides low-loss and can be removed from the amplification band such that there is minimal impact on the gain profile of the optical amplifier when slope compensation is not desired. As is well known to one of ordinary skill in the art, LPGs are fiber-based loss filters that couple a core mode to thermally-tuned leaky cladding modes to provide a loss spectrum (loss as a function of wavelength). Tunable LPGs can be made by coating the cladding with an overcladding material whose refractive index changes with temperature, e.g., sol gel. As long as the refractive index of the overcladding material is above that of the silica (i.e., the core and the cladding), the LPG can be thermally tuned to provide a desired gain tilt (see FIG. 4), by changing the amplitude of the loss spectrum (see FIG. 3, for example).

According to the present invention, the loss peak of a tunable LPG is designed to be broad enough such that the trailing edge or the leading edge of the loss peak, or both, cover the entire amplification band (e.g., forty nanometers) of an optical amplifier (e.g., EDFA). As such, either edge of the band can be used to introduce a wavelength dependent loss or loss slope, which is linearly dependent on the wavelength. When the amplitude of the LPG is thermally tuned, the loss slope in the band is modified accordingly. Utilizing two independent LPGs, residing at either end of the amplification band, allows the loss slope in the band to be changed in either a negative or positive direction.

As stated above, when slope compensation is not desired, the DSCF can be completely shifted out of the amplification band (e.g., EDFA window) leaving virtually no ripples in the band. This is done by thermally tuning the refractive index of the overcladding below that of the silica cladding such that the LPG couples the core mode to guided cladding modes, which cause the LPG peaks to shift to shorter wavelength and the peak width to get narrower. By accurately controlling the coupler temperature, the LPG wavelength can be shifted by more than forty nanometers. Shifting the wavelength more than forty nanometers typically allows the LPG to be hidden at either end of the amplification band, by shifting the LPG out of the amplification band.

The DSCF, described above, can be used in conjunction with gain flattening filters (GFFs) that are fixed or tunable (e.g., LPG based). When the DSCF is utilized with a tunable GFF, the tunable GFF can perform fine-tuning of the amplification band, which typically improves or extends the tilt correction capability of the DSCF. With such a configuration, the DSCF and the tunable GFF can share the same control circuit and potentially be advantageously integrated in a single package, as a fiber-based tunable GFF with slope compensation.

While the discussion herein is primarily directed to long-period grating (LPG) filters, one of ordinary skill in the art will readily appreciate that tapered pathways and other perturbations can be utilized along an optical waveguide to couple light from the core into a surrounding cladding. As is well known to one of ordinary skill in the art, surrounding the cladding of the long-period grating with a thermally sensitive overcladding whose refractive index varies, based upon the temperature of the overcladding, allows a band of wavelengths to be tuned. When the refractive index of the overcladding is below that of the cladding, the cladding mode attenuation bands shift toward lower wavelengths and decrease in amplitude as the overcladding refractive index approaches the cladding refractive index. The attenuation bands substantially disappear when the overcladding refractive index matches the cladding refractive index, because the cladding modes are no longer guided. When the refractive index of the overcladding is above the refractive index of the cladding, the attenuation bands reappear and increase in amplitude without shifting the wavelengths of the amplification band. Selecting an appropriate grating allows a tunable LPG to achieve a loss peak that is broad enough such that the trailing edge or the leading edge of the peak, or both, cover the entire amplification band (e.g., forty nanometers), of an optical amplifier (e.g., EDFA). In this manner, gain tilt compensation, according to the present invention, can be implemented.

In a preferred embodiment, the filter includes a waveguide including a core and cladding that guide a light beam having a range of wavelengths along the core. The core includes a coupler (e.g., a long-period grating) that couples light at least one band of the wavelengths from the core into the cladding. An overcladding covers at least a portion of the cladding and exhibits a refractive index that can be adjusted in a range from below the refractive index of the cladding to above the refractive index of the cladding. When the refractive index of the overcladding is above the refractive index of the cladding, at least a portion of the band of wavelengths is coupled to the overcladding. Preferably, the refractive index of the overcladding is adjusted by changing the power delivered to a heater, that substantially covers the overcladding.

The heater can, for example, be constructed through vapor deposition of a metal on the overcladding. Preferably, a processor, which is coupled to an output of a spectral monitor, varies the current supplied to the heater, as a function of the signal output from the monitor. While the coupler is preferably a long-period grating (LPG), one of ordinary skill in the art will readily appreciate that other coupling structures, such as a tapered filter, a lattice filter or a fused-fiber device, can be utilized to couple light from core modes into cladding modes. Preferably, the coupler is located along the waveguide within a region covered by the overcladding and is also preferably athermalized to inhibit a shift in the central wavelength of the amplification band as a function of the waveguide temperature. As is well known to one of ordinary skill in the art, the band of wavelengths coupled from the core to the cladding is set by the period of the LPG.

The overcladding preferably exhibits a refractive index that varies as a function of temperature. In a preferred embodiment, the overcladding is an optical material having a negative dn/dT (i.e., where ‘n’ is the refractive index and ‘T’ is the temperature). A suitable overdladding is an inorganic-organic hybrid material, commonly referred to as a hybrid sol gel, which has a refractive index that can be higher than a typical silica cladding and a rate of refractive index change with temperature of approximately −3×10⁻⁴. The hybrid material preferably includes an extended matrix containing silicon and oxygen atoms with at least some of the silicon atoms being directly bonded to substituted or unsubstituted hydrocarbon moieties. When in a solid form, the hybrid material provides structural support and protection for the underlying core and cladding, and can also be formulated to resist bending for safeguarding the performance of the grating.

A processor preferably operates a temperature conditioner (e.g., a heater) that adjusts the temperature of the overcladding to vary the refractive index of the overcladding within a range that is lower and higher than the refractive index of the cladding. The temperature conditioner can be formed as a resistive heater that is in thermal contact with the overcladding. Other heaters or coolers can be used to produce a desired temperature range for the overcladding corresponding to a range of overcladding refractive indices that are above and below the refractive index of the cladding.

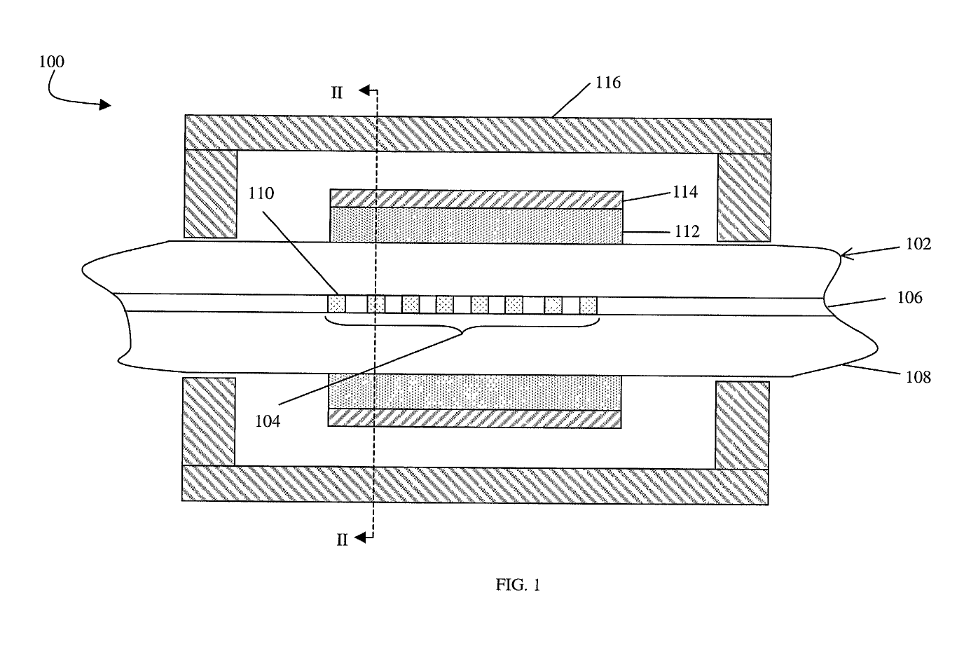

Turning to FIG. 1, a dynamic slope compensation filter (DSCF) 100 is shown. A coupler (i.e., a long-period grating (LPG)) 104 is formed in a core 106 of waveguide 102. Preferably, both the core 106 and the surrounding cladding 108 are formed primarily of silica. Preferably, the core 106 is doped with an index raising dopant such as GeO₂, to allow light to be guided, and codoped with a dopant such as B₂O₃, to athermalize the core mode to cladding mode coupling. A ratio of the dopant to the codopant is preferably in a range of 1.5:1 to 8:1.

The waveguide 102 can be made with a flame hydrolysis apparatus using an outside vapor deposition method to form the silica core 106, which is doped with GeO₂ and codoped with B₂O₃. Vaporous feedstock levels of these materials are typically delivered to a flame hydrolysis burner to provide the desired material concentration to the core 106 and the cladding 108. The GeO₂ concentrations in the core 106 also provide photosensitivity for writing the LPG 104. The core 106 is exposed to periodic bands of ultraviolet light that alter the refractive index of alternating axial segments 110 of core 106. The alternating axial segments 110 can be individually exposed by moving the waveguide 102 relative to an ultraviolet source or collectively exposed by using a masking technique. An overcladding 112 surrounds waveguide 102 in the region of the LPG 104. Overcladding 112 has a refractive index that is variable in a range from below the refractive index of the cladding 108 to above the refractive index of the cladding 108. The refractive index of the overcladding 112 is preferably sensitive to temperature changes and exhibits a change in refractive index that is proportional to the change in temperature. As discussed above, the preferred overcladding 112 is a sol gel material, preferably in a solid form, that is a combination of organic and inorganic hybrids.

Discrete changes in the refractive index ‘n’ of a surrounding medium can affect the different cladding modes. A paper entitled “Analysis of the Response of Long-Period Fiber Gratings to External Index of Refraction”, published in the Journal of Lightwave Technology, Vol. 15, No. 9, Sep. 19, 1998, provides an explanation of how discrete changes in the refractive index can affect different cladding modes and is hereby incorporated by reference. Increasing the refractive index of the overcladding 112 reduces both the coupling strength and the corresponding amount of attenuation of longer coupled spectral bands, without shifting the central wavelengths of these bands. Further, designing a tunable LPG with a loss peak that is broad enough such that the trailing edge or the leading edge of the peak, or both, can cover the entire amplification band (e.g., forty nanometers) of an optical amplifier (e.g., EDFA) allows gain tilt compensation, according to the present invention, to be achieved. It is contemplated that variations of the present invention may prove useful in solving similar problems in other optical amplifiers (e.g., Raman amplifiers, semiconductor optical amplifiers (SOAs), etc.).

Other materials, such as polymers, can be used as the overcladding 112 to provide similar variations in the refractive index, as a function of temperature. Polymers with temperature sensitive refractive indices are disclosed in a paper entitled “Widely Tunable Long-Period Fibre Gratings,” by A. A. Abramov et al., published in the Electronics Letters, Jan. 7, 1999, Vol. 35, No. 1, and is hereby incorporated by reference.

According to the present invention, a temperature conditioner 114, such as a resistive heater, is in thermal contact with the overcladding 112. Electrical current flows through the heater and can be controlled to adjust the temperature of the overcladding 112 to produce a change in the refractive index of the overcladding 112. Alternatively, a cooler could be used in place of, or in addition to, the heater to vary the range of the overcladding temperature that can be achieved. Preferably, the range of temperatures applied to the overcladding 112 are within a range in which the LPG 104 is athermalized, which avoids wavelength shifts caused by temperature variations in the core 106 and cladding 108. The temperature conditioner 114 can be surrounded by a rigid tube 116, that provides structural support to prevent bending or other disturbances of the coupler (e.g., LPG 104).

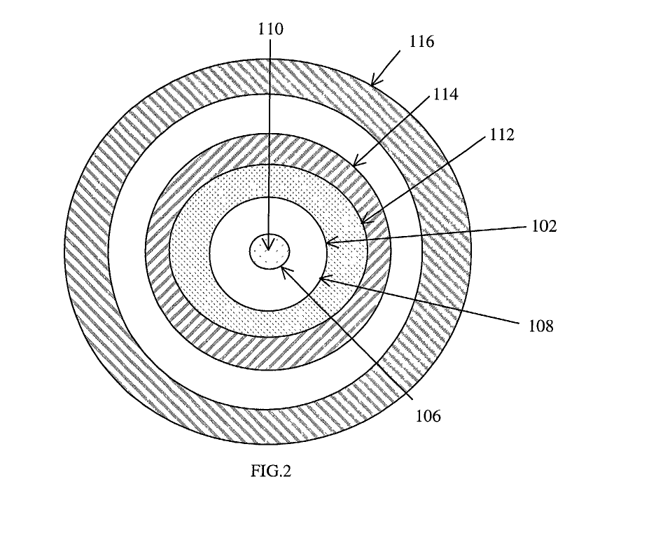

Moving to FIG. 2, a transverse cross-sectional view of the dynamic slope compensation filter (DSCF) of FIG. 1 is shown, along the line II-II. Preferably, the DSCF is formed as a circular waveguide. However, one of ordinary skill in the art will appreciate that non-circular waveguides (e.g., planar waveguides) can also potentially be utilized.

Turning to FIG. 3, an exemplary graph depicting the insertion loss spectra of a tunable long-period grating (LPG) filter, as a function of grating temperature, is illustrated. As shown in FIG. 3, as long as the refractive index of the overcladding (e.g., sol gel) is above that of the silica, the LPG can be thermally tuned in amplitude while the grating wavelengths remain unchanged. Waveforms 300 and 302 show an exemplary insertion loss spectra at 20° C. and 40° C., respectively. Waveform 304 shows an exemplary insertion loss spectra at 60° C. and waveform 306 shows an exemplary loss spectra at 80° C. As discussed above, the principal of a tunable LPG is to couple the core mode to thermally-tuned leaky cladding modes. By selecting an appropriate coupler, a loss peak of a tunable LPG can be designed broadly enough that either the trailing edge or the leading edge of the peak covers the entire amplification band (e.g., an EDFA window). While the spectral response of an LPG is fiber dependent, most any LPG can be made spectrally wider by decreasing the length of its grating. According to an embodiment of the present invention, either edge can be used to introduce a wavelength dependent loss slope, which is linearly dependent on the wavelength to a first order of approximation. When the LPG is thermally tuned, the loss slope changes accordingly. For example, as the temperature is increased, the loss decreases.

FIG. 4 depicts an exemplary insertion loss spectra of a dynamic slope compensation filter (DSCF) in the L-band as a function of the input power applied to a heater, according to an embodiment of the present invention. As shown in FIG. 4, the LPG has its trailing edge in the band of interest. The loss slope can change in a negative or positive direction if there are two independent LPGs residing at each end of the amplification band of the optical amplifier (e.g., EDFA window). Waveforms 400 and 402 show exemplary plots of the insertion loss spectra with no input power applied to the heater and 480 milliwatts applied to the heater, respectively. Waveform 404 illustrates an exemplary insertion loss spectra with 680 milliwatts of input power applied to the heater and waveform 406 represents the insertion loss spectra with 770 milliwatts of input power applied to the heater.

As illustrated in FIG. 4, the gain tilt (i.e., slope) can be modified through the application of current to the heater 114 (e.g., a resistive heater) that is in thermal contact with the overcladding 112 of the dynamic slope compensation filter (DSCF) 100. As previously discussed, when slope compensation is not desired, the DSCF 100 can be completely shifted out of the amplification band (e.g., EDFA window). As discussed above, this is accomplished by thermally tuning the refractive index of the overcladding 112 (e.g., sol gel) below that of the silica (i.e., cladding 108), such that only guided cladding modes are present. That is, the overcladding 112 does not carry light when its refractive index is below that of the cladding 108. When the coupler temperature is accurately controlled, the LPG wavelength shift can typically be more than forty nanometers, which allows the LPG to be hid at either end of the amplification band.

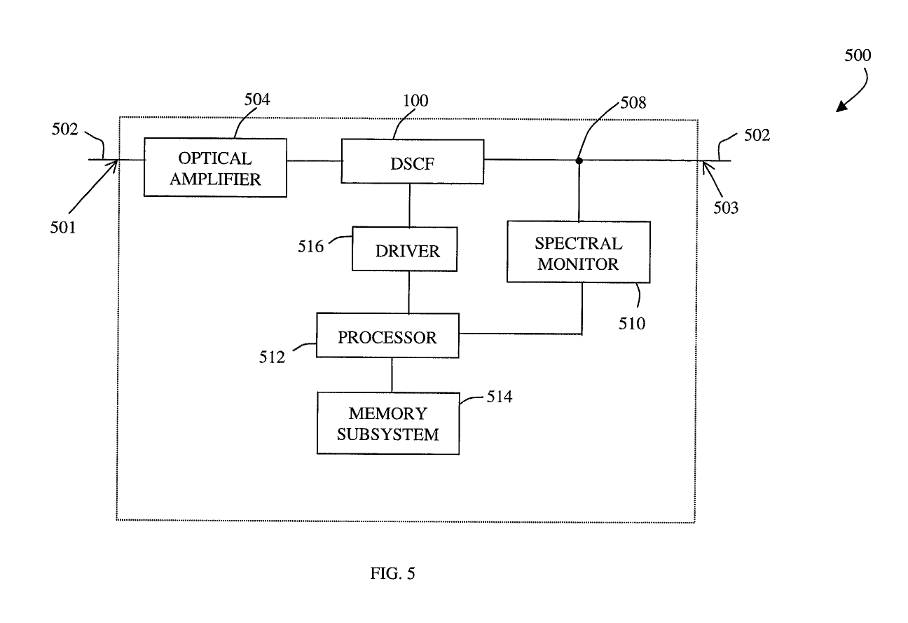

FIG. 5 illustrates an optical amplifier module 500 that includes a dynamic slope compensation filter 100, according to an embodiment of the present invention. A spectral monitor 510 is coupled to an output of the DSCF 100 through a tap 508 (e.g., a one percent tap). Output signals of the spectral monitor 510 are applied to an input of processor 512. Processor 512 is coupled to memory subsystem 514, which contains an application appropriate amount of volatile and non-volatile memory. Memory subsystem 514 contains a routine, which allows processor 512 to control DSCF 100 based upon output signals from the spectral monitor 510. As shown in FIG. 5, an optical fiber 502, that requires amplification of the signals that it is carrying, is coupled to the optical amplifier module 500 at input 501 and output 503. Processor 512 responds to the input signals from the monitor 510 and an algorithm in the memory subsystem 514 to provide a control signal to driver 516. The control signal dictates the amount of current delivered to the resistive heater 114, of DSCF 100, to vary the temperature of the overcladding 112 (FIG. 1) to control the refractive index of the DSCF 100 and thus, the gain tilt of the optical amplifier module 500.

In summary, an optical filter that provides dynamic slope modification for an optical amplifier has been described. The optical filter includes an optical waveguide core for guiding a plurality of wavelengths, an optical waveguide cladding surrounding the core and an optical waveguide overcladding surrounding at least a portion of the cladding. The core has a core refractive index and includes at least one coupler that functions to couple a plurality of wavelengths from the core to the cladding. The cladding has a cladding refractive index that is less than the core refractive index. The overcladding has a variable overcladding refractive index that is adjustable within a range that is less than and greater than the cladding refractive index. Preferably, the coupler is athermalized to substantially inhibit a shift in the amplification band with respect to temperature. At least one of a trailing edge and a leading edge of a filter loss peak of the filter covers substantially all of the amplification band. An advantage of the present invention is that it includes a practical all fiber solution to addressing gain tilt associated with optical amplifiers.

It will become apparent to those skilled in the art that various modifications to the preferred embodiment of the invention as described herein can be made without departing from the spirit or scope of the invention as defined by the appended claims.

The invention claimed is:

1. A dynamic slope compensation filter that provides dynamic gain slope modification for an optical amplifier, the optical amplifier providing amplification for a plurality of wavelengths within an amplification band, the filter comprising:
an optical waveguide core for guiding a plurality of wavelengths, the core including at least one coupler and having a core refractive index;
an optical waveguide cladding surrounding the core, wherein at least one coupler couples at least a portion of the plurality of wavelengths from the core to the cladding, the cladding having a cladding refractive index that is less than the core refractive index; and
an optical waveguide overcladding surrounding at least a portion of the cladding, the overcladding having a variable overcladding refractive index that is adjustable within a range that is less than and greater than the cladding refractive index, wherein at least one of a trailing edge and a leading edge of a filter loss peak of the filter covers substantially all of the amplification band.

2. The filter of claim 1, wherein the optical amplifier is an erbium-doped fiber amplifier, the filter is a long-period grating filter and the amplification band is at least about thirty nanometers.

3. The filter of claim 1, wherein the coupler is athermalized to substantially inhibit a shift in the amplification band as a function of temperature.

4. The filter of claim 1, wherein the overcladding refractive index varies as a function of temperature.

5. The filter of claim 1, wherein the overcladding is a sol gel material.

6. The filter of claim 1, further including:
a resistive heater in thermal contact with the overcladding for providing a range of temperatures to the overcladding which change the overcladding refractive index.

7. The filter of claim 1, wherein the at least one coupler is located in the core of the waveguide within a region covered by the overcladding.

8. The filter of claim 1, wherein the filter does not perform gain slope compensation when the overcladding refractive index is less than the cladding refractive index.

9. The filter of claim 1, wherein the filter performs gain slope compensation when the overcladding refractive index is greater than the cladding refractive index.

10. An optical amplification system that provides amplification and dynamic gain slope modification for a plurality of wavelengths, the optical system comprising:
an optical amplifier;
an optical filter coupled to the optical amplifier, the optical filter including:
an optical waveguide core for guiding a plurality of wavelengths, the core including at least one coupler and having a core refractive index;
an optical waveguide cladding surrounding the core, wherein the at least one coupler functions to couple at least a portion of the plurality of wavelengths from the core to the cladding, the cladding having a cladding refractive index that is less than the core refractive index, wherein at least one of a trailing edge and a leading edge of a filter loss peak of the filter covers substantially all of the amplification band; and
an optical waveguide overcladding surrounding at least a portion of the cladding, the overcladding having a variable overcladding refractive index that is adjustable within a range that is less than and greater than the cladding refractive index;
a resistive heater in thermal contact with the overcladding for providing a range of temperatures to the overcladding which change the overcladding refractive index;
a spectral monitor including an input that is coupled to the optical amplifier and an output; and
a processor having an input coupled to the output of the spectral monitor and an output coupled to the resistive heater, the processor programmed to control the temperature of the resistive heater in response to signals provided by the output of the spectral monitor.

11. The system of claim 10, wherein the optical amplifier is an erbium-doped fiber amplifier, the filter is a long-period grating filter and the amplification band is at least about thirty nanometers.

12. The system of claim 10, wherein the coupler is athermalized to substantially inhibit a shift in the amplification band as a function of temperature.

13. The system of claim 10, wherein the overcladding refractive index varies as a function of temperature.

14. The system of claim 10, wherein the overcladding is a sol gel material.

15. The system of claim 10, wherein the at least one coupler is located in the core of the waveguide within a region covered by the overcladding.

16. The system of claim 10, wherein the optical amplifier is an erbium-doped fiber amplifier, the filter is a long-period grating filter and the amplification band is at least about forty nanometers.

17. The system of claim 10, wherein the optical filter does not perform gain slope compensation when the overcladding refractive index is less than the cladding refractive index.

18. The system of claim 10, wherein the optical filter performs gain slope compensation when the overcladding refractive index is greater than the cladding refractive index.

19. A method for providing dynamic gain slope modification for an optical amplifier, the optical amplifier being coupled to an optical filter, the optical amplifier providing amplification for a plurality of wavelengths within an amplification band, the method comprising the steps of:
providing an optical filter that includes:
an optical waveguide core for guiding a plurality of wavelengths, the core including at least one coupler and having a core refractive index;
an optical waveguide cladding surrounding the core, wherein the at least one coupler functions to couple at least a portion of the plurality of wavelengths from the core to the cladding, the cladding having a cladding refractive index that is less than the core refractive index; and
an optical waveguide overcladding surrounding at least a portion of the cladding, the overcladding having a variable overcladding refractive index that is adjustable within a range that is less than and greater than the cladding refractive index, wherein at least one of a trailing edge and a leading edge of a filter loss peak of the filter covers substantially all of the amplification band;
monitoring the spectral output of the optical amplifier to determine a gain tilt of the optical amplifier; and
adjusting the overcladding refractive index to achieve a desired gain tilt for the optical amplifier.

20. The method of claim 19, wherein the optical amplifier is an erbium-based fiber amplifier, the filter is a long-period grating filter and the amplification band is at least about thirty nanometers.

21. The method of claim 19, wherein the coupler is athermalized to substantially inhibit a shift in the amplification band as a function of temperature.

22. The method of claim 19, wherein the overcladding refractive index varies as a function of temperature.

23. The method of claim 19, wherein the overcladding is a sol gel material.

24. The method of claim 19, wherein the optical fiber further includes:
a resistive heater in thermal contact with the overcladding for providing a range of temperatures to the overcladding which change the overcladding refractive index.

25. The method of claim 19, wherein the at least one coupler is located in the core of the waveguide within a region covered by the overcladding.

26. The method of claim 19, wherein the filter does not perform gain slope compensation when the overcladding refractive index is less than the cladding refractive index.

27. The method of claim 19, wherein the filter performs gain slope compensation when the overcladding refractive index is greater than the cladding refractive index.
